(19) United States
(12) Patent Application Publication
(10) Pub. No.: US 2015/0375455 A1
(43) Pub. Date: Dec. 31, 2015

(54) THREE-DIMENSIONAL SCANNING WATERMARK

(71) Applicant: Amazon Technologies, Inc., Reno, NV (US)

(72) Inventors: Robert Vaughn Williams, Edmonds, WA (US); Robert Howard Curtis, JR., Edmonds, WA (US); Georges Raouf Georges Bargoud, Seattle, WA (US); Rotem Hershko, Seattle, WA (US)

(21) Appl. No.: 14/317,516

(22) Filed: Jun. 27, 2014

(51) Int. Cl. B29C 67/00

(52) U.S. Cl. CPC B29C 67/0088

(57) ABSTRACT

Markers may be included in items manufactured on demand by a manufacturing apparatus. The markers in such marked items may be detected by a scanning apparatus, and information and/or instructions associated with printing three-dimensional objects can be provided based on the markers.

### CROSS-REFERENCE TO RELATED APPLICATIONS

This application is related to and incorporates by reference for all purposes the full disclosure of co-pending U.S. patent application Ser. No. ______, filed concurrently herewith, entitled “THREE-DIMENSIONAL WATERMARK GENERATION” (Attorney Docket No. 90204-909706 (079600US)).

### BACKGROUND

In the modern age of e-commerce, many items are bought or sold electronically. To facilitate such an electronic transaction, a service provider may provide a network site or other electronic marketplace through which a customer can select and order an item. The item may be one of many items offered by the electronic marketplace. The electronic marketplace may have systems for identifying the selected item and ensuring that the item is delivered to the customer. If the item delivered to the customer can be easily reproduced by the customer, the customer may opt to personally produce additional copies of the item rather than purchase additional copies of the item from the electronic marketplace. Such non-purchased copies of the item may reduce demand for the electronic marketplace services and affect revenues generated thereby. Non-purchased copies may also lack quality controls in place during original production of the item offered by the service provider, which may subject the customer to products of an inferior—or even dangerous—nature.

### BRIEF DESCRIPTION OF THE DRAWINGS

Various embodiments in accordance with the present disclosure will be described with reference to the drawings, in which:

FIG. 1 is a schematic diagram showing an example system for providing one or more marked items via computer systems of a service provider and/or for identifying marked items in accordance with at least one embodiment;

FIG. 2 is a schematic diagram depicting an illustrative system or architecture in which techniques for providing and/or identifying marked items may be implemented in accordance with at least one embodiment;

FIG. 3 is a flow chart representing a process for providing a marked item in accordance with embodiments.

FIG. 4 is a flow chart representing a process for identifying a marked item in accordance with embodiments.

FIG. 5 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described herein include marking items that are manufactured on demand, such as by three-dimensional (3D) printing, to include information about the item and/or identifying items marked in such a manner. The marker may be unobtrusive or not readily discernible by the user, serving as a latent physical “watermark” for providing information about the item to systems capable of detecting and/or interpreting the marker.

In some examples, a plastic figurine printed by a 3D printer may include an embedded arrangement of dots or other material (e.g., a material responsive to a particular frequency of ultraviolet light but invisible to a human eye) that can be detected by a device (e.g., with a scanner) and interpreted to indicate the designer of the figurine, the date the figurine was printed, and/or whether the device is permitted to obtain data for a virtual model of the figurine from which further copies of the figurine may be printed.

As an illustrative example, a designer may generate three-dimensional instructions for printing a three-dimensional object. The three-dimensional instructions may be provided to a three-dimensional printing/manufacturing apparatus (hereinafter “3D printer”). The 3D printer may be equipped to print a 3D version of the object and to embed a 3D watermark as part of the 3D object. Upon request by the designer, the 3D printer may generate and/or prepare one of many different types of appropriate 3D watermarks and then print the 3D watermark within, on, or otherwise as part of the 3D object. Thus, the 3D object may now include a 3D watermark that can identify information about the 3D object, the designer, and/or copy permissions. Using a second 3D printer, which may be the original 3D printer that printed the 3D object, a scanning component may scan the 3D object and detect the 3D watermark. Based at least in part on the 3D watermark, the second 3D printer may be able to identify whether appropriate permission and/or rights have been granted for copying the 3D object (e.g., to reprint a second version of the 3D object. Information from the 3D watermark may be used to look up data (e.g., within a central database) associated with the 3D object and/or its associated copy permissions. Thus, copyrights of the 3D object and/or the original design of the 3D object may be managed by the 3D watermark embedded in the 3D object.

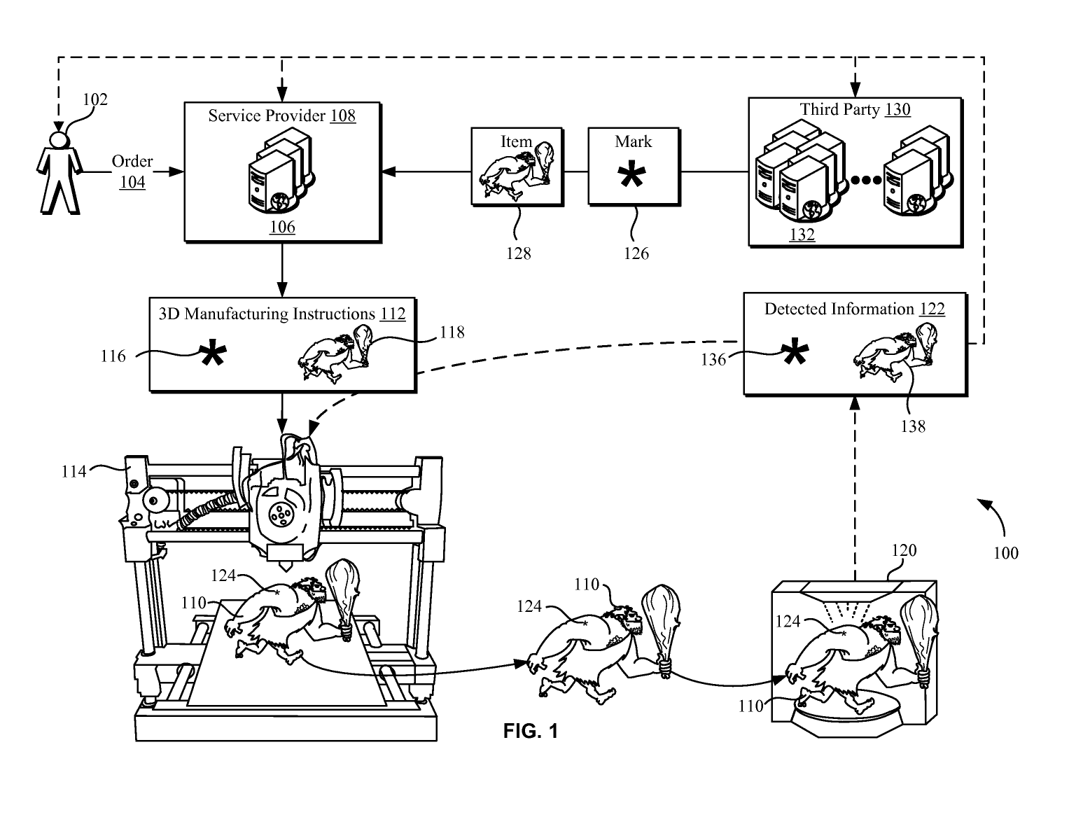

FIG. 1 shows an example system 100 through which one or more marked items 110 can be provided via a computer system 106 of a service provider 108. A user 102 can submit an order 104 via a personal computing device (described below) to computer systems 106 of the service provider 108. For example, the user 102 can submit an order 104 for an item offered in an electronic marketplace and request that the item be manufactured on demand by a manufacturing apparatus 114, e.g., a three-dimensional (3D) manufacturing apparatus. The computer systems 106 of the service provider 108 can provide 3D manufacturing instructions 112 for manufacturing the ordered item by a 3D manufacturing apparatus 114. A marker 124 can be included in the marked item 110 during manufacture by the 3D manufacturing apparatus 114. To this end, the manufacturing instructions 112 may incorporate item information 118 (i.e., details about the ordered item) as well as marker information 116 (i.e., details about the marker 124). In some embodiments, the computer system 106 of a service provider 108 may determine and/or generate the item information 118 and/or the marker information 116 based on item information 128 and/or marker information 126 received from a third party 130 (e.g., through computer systems 132 of the third party 130). The marker 124 may be any suitable distinguishing feature (such as a characteristic or arrangement of a particular material), and various examples of markers 124 are described in greater detail herein.

The system 100 depicted in FIG. 1 may additionally or alternatively facilitate identifying marked items 110. A scanning apparatus 120 may scan or otherwise sense attributes about the marked item 110 to obtain detected information 122. The scanning apparatus 120 is typically owned by or otherwise accessible to the user 102. The detected information 122 (e.g., scanned information) may include item information 138 (i.e., details about the scanned item) and/or marker information 136 (i.e., details about the marker 124). The marker information 136 may include permissions information and/or instructions that certain actions be performed based on the marker information 136. In one example, the marker information 136 from the detected information 122 may include instructions to communicate some interpretation and/or portion of the detected information 122 to a user 102, a service provider 108, a third party 130, and/or a manufacturing apparatus 114. In another example, the marker information 136 from the detected information 122 may indicate whether reproduction based on the marked item 110 is permitted.

An illustrative example of the operation of the system 100 depicted in FIG. 1 follows. After careful consideration, a person decides that a figurine of a bearded Paleolithic man would be the perfect “inside-joke” keepsake for a co-worker. The person (the user 102 in this illustrative example) utilizes his or her smartphone to access an electronic marketplace network page (provided by the computer systems 106 of a service provider 108 in this example). The user 102 places an order (i.e., 104 in FIG. 1) for a product entitled “PALEO-BEARD-MAN” (i.e., the aforementioned figurine) on the network page, requesting delivery via printing on the user's home 3D printer (i.e., the manufacturing apparatus 114 in this example). The computer systems 106 interact with a database maintained by the designer of PALEO-BEARD-MAN (i.e., computer systems 132 of a third party 130) and receive a digital 3D model (i.e., item information 128) and a request that a link to an interface with the designer's licensing department be encoded into all instances of PALEO-BEARD-MAN (i.e., marker information 126). The computer systems 106 then generates printing instructions for the user's 3D printer (i.e., the 3D manufacturing instructions 112 for the 3D manufacturing apparatus 114). The printing instructions direct the printer to deposit a primary material in layers that will produce a complete PALEO-BEARD-MAN (i.e., item information 118) and also direct the printer to deposit a specific pattern of a secondary material in the midst of the penultimate layer (i.e., marker information 116). Following these instructions, the user's printer produces a PALEO-BEARD-MAN having the specific pattern of secondary material located just below the surface and thus invisible to the user (i.e., the marked item 110 having the marker 124). Elated with the gift, the co-worker places the PALEO-BEARD-MAN in his or her own combined 3D scanner-printer (i.e., a device containing a scanning apparatus 120 and a manufacturing apparatus 114) in order to make copies for family members. During scanning (i.e., obtaining detected information 122), the scanning apparatus 120 uses an infrared sensor to identify the pattern of secondary material (i.e., the marker 124) within the PALEO-BEARD-MAN based on the distinct infrared signature of the secondary material. The scanning may also provide sufficient data to create a new digital model of the PALEO-BEARD-MAN (i.e., item information 138 of the detected information 122). The detected pattern of secondary material is decoded to determine information conveyed by the marker (i.e., the marker information 136 of the detected information 122). In this illustrative example, based on the marker information 136, the link to the interface with the designer's licensing department is provided to the co-worker (i.e., a user 102), and the manufacturing apparatus 114 is instructed to refrain from using the newly created digital model to produce a copy of PALEO-BEARD-MAN until the co-worker has had a chance to decide if he or she would prefer to instead use verified manufacturing instructions 112 available through the interface with the designer's licensing department.

In accordance with at least one embodiment, the 3D manufacturing apparatus 114 may include a 3D printer or some other 3D or multi-dimensional manufacturing apparatus(es) 114 described herein. As may be appreciated, the term “manufacture” connotes production of a physical object. The 3D manufacturing apparatus 114 may utilize any manufacturing technique that can be used to produce a three-dimensional physical object based on the 3D manufacturing instructions 112. Both additive and subtractive manufacturing processes can be utilized individually or in combination. For example, manufacturing techniques can include fused deposition modeling, electron beam freeform fabrication, direct metal laser sintering, electron beam melting, selective laser melting, selective heat sintering, selective laser sintering, laminated object manufacturing, stereo lithography, digital light processing, and any 3D printing, including plaster-based, powder bed, and inkjet head 3D printing. Manufacturing techniques may also include automation of machine tools based on a digital model such as in computer numerical control (or CNC) techniques. Combinations of such techniques may also be employed, such as 3D printing an item to include supports under a suspended portion and cutting away the supports with an automated tool after the suspended portion has cured sufficiently to obviate the supports.

The 3D manufacturing instructions 112 can include any type of data and/or instructions that can be used by a 3D manufacturing apparatus 108 to make an item. The 3D manufacturing instructions 112 can include any data or instructions utilized in producing a physical object based on a digital model or data of the object. In one example, 3D manufacturing instructions 112 may include combinations of dimensions, tolerances, and/or other part specifications that sufficiently describe the attributes of an item such that the item can be physically produced by a 3D manufacturing apparatus 114. In another example, 3D manufacturing instructions 112 may include digital models such as may be provided by Computer-Aided-Design (CAD) files or files for computer modeling programs. In another example, 3D manufacturing instructions 112 may include files in STL, PLY, or VRML formats, to name a few. In another example, 3D manufacturing instructions 112 may also include files representing cross sections of digital models referenced for building physical models one layer at a time. In another example, 3D manufacturing instructions 112 may also include executable code providing specific sequential instructions for controlling a 3D manufacturing apparatus 114 to produce a physical object.

In embodiments, the computer systems 106 of the service provider 108 can provide for an electronic marketplace. An electronic marketplace can be a virtual market for buyers and sellers implemented through a network. An electronic marketplace can provide an interface for sellers such that a plurality of sellers can provide items to be listed for consumption in the virtual market. An electronic marketplace can also provide an interface for buyers such that buyers may select and order from among the listed items. In embodiments, buyers and sellers can include users 102, the third parties 130, and the service provider 108. For example, users 102 can submit orders 104 for items listed in the electronic marketplace by the service provider 108 or third party 130. In embodiments, the third parties 130 can provide data associated with the 3D manufacturing instructions 112 that can be used to produce marked items 110 via a 3D manufacturing apparatus 114. For example, the third parties 130 may provide marker information 126, item information 126, and/or manufacturing instructions 112.

Item information (such as that designated by 118, 128, and/or 138 in FIG. 1) can include details about a designated item, such as the structure, geometry, material qualities, other characteristics, or combinations thereof. Marker information (such as that designated by 116, 126, and/or 136 in FIG. 1) can include details about the marker 124, such as the type, size, material, meaning, manner of implementation by a manufacturing apparatus, or combinations thereof. In some embodiments, the marker information 116 may include information about implementing the marker 124 without substantially altering characteristics designated by the item information 118. Furthermore, as may be appreciated, the item information or marker information designated by one reference number in FIG. 1 need not necessarily be precisely the same as item information or marker information designated by another reference number in FIG. 1. For example, as set forth in the previous illustrative example that references PALEO-BEARD-MAN, marker information 126 may include an intended meaning of the marker 124 while marker information 116 includes instructions for the manner in which the manufacturing apparatus 114 is to implement the marker 124, and while marker information 136 includes an interpretation of the marker 124.

In some embodiments, the marker information 116 and the item information 118 can be synthesized together in the 3D manufacturing instructions 112. As illustrative examples, the 3D manufacturing instructions 112 may be a single virtual model representing the mark 124 incorporated into the marked item 110 or an executable code providing sequential instructions for making the marked item 110 with the marker 124 therein. In some embodiments, the marker information 116 and the item information 118 can be distinct elements of the 3D manufacturing instructions 112. As an illustrative example, the 3D manufacturing instructions 112 may include item information 118 regarding constructing the marked item 110 and separate marker information 116 that indicates the type of marker 124 designated so that the 3D manufacturing apparatus 114 can determine how to adjust construction of the marked item 110 to include the mark 124. Likewise, information provided by a third party 130 may include combined or separate item information 128 and marker information 126 and may include one without the other. Similarly, detected information 122 may include mixed or distinct item information 138 and marker information 136 and may include one without the other. For example, a scanning apparatus 120 may perform an operation for detecting a marker 124 and/or obtaining marker information 136 before or without concurrently performing an operation for obtaining item information 138.

In embodiments, the detected information 122 (or information based on the detected information 122) may be communicated to other components or entities to facilitate various functions. For example, the detected information 122 may be communicated to a manufacturing apparatus 114 as a basis for generating and/or modifying manufacturing instructions 112 utilized by the manufacturing apparatus 114 to make items 110. As further illustrative examples, the detected information 122 may be communicated to a user 102, a service provider 108, and/or a third party 130 to facilitate functions such as providing or requesting additional information about the marked item 110.

A single piece of equipment may include both the 3D manufacturing apparatus 114 and the scanning apparatus 120. However, the 3D manufacturing apparatus 114 and the scanning apparatus 120 may also be distinct pieces of equipment, which may be operated by or associated with different entities. In some embodiments, a first 3D manufacturing apparatus 114 may make the marked item 110, and a separate scanning apparatus 120 can interface with a second 3D manufacturing apparatus 114 for making or restricting copies of the marked item 110 based on the marker 124.

The 3D manufacturing apparatus 114 and/or the scanning apparatus 120 may be operated by or associated with the service provider 108, a user 102, and/or a third party 130. Appropriate intermediary operations may be implemented to transfer the marked item 110 to an intended recipient from whatever entity controls the 3D manufacturing apparatus 114 and/or the scanning apparatus 124. For example, a marked item 110 produced to fulfill an order 104 of a user 102 may be produced on a manufacturing apparatus 114 controlled by the service provider 108 and may be delivered to the user 102 based on delivery information provided by the user via truck delivery or any suitable delivery method, including standard mail, air mail, truck, aerial drone, or deposit at a designated pick-up location. In some embodiments, the order 104 may be fulfilled by providing manufacturing instructions 112 that a user 102 may use with a personal manufacturing apparatus 114 to produce a marked item 110.

The marker 124 can be any suitable distinguishing feature detectable by the scanning apparatus 120. For example, according to differing embodiments, the distinguishing feature may be a characteristic of a material out of which the entire marked item 110 is constructed, the presence of a distinct material in the marked item 110, or a pattern that is detectable based on differences between materials included in the marked item 110. In some embodiments, a single distinctive material can provide any of these distinguishing features. As an illustrative example, a manufacturing apparatus 114 may fabricate items from a plastic that may be either mixed with an ultraviolet pigment (i.e., “ultraviolet plastic”) or utilized without the pigment (i.e., “regular plastic”). Depending on the manner in which the manufacturing apparatus 114 utilizes the ultraviolet plastic, the marker 124 may be that the item 110 is formed of all ultraviolet plastic, contains merely a dot of the ultraviolet plastic in a structure of regular plastic, or contains an identifiable pattern of dots of ultraviolet plastic dispersed in the regular plastic. In some embodiments, a marker 124 may include data or metadata encoded within a pattern, such as in a bar code, QR code, text string, numeric string, symbol, or some combination thereof.

Numerous options exist for providing a marker 124. In various embodiments, the marker 124 may include one or more materials having a particular distinguishing characteristic. As non-limiting examples, the marker 124 may include material that has a particular response to a given segment of the electromagnetic spectrum (such as radio waves, ultraviolet light, infrared light, or visible light), a particular color, a particular smell, a particular density, a particular biological quality, a particular magnetic property, a particular electrical conductivity property, a particular physical characteristic, a particular chemical characteristic, or a particular atomic characteristic. The marker 124 may include a pattern formed of materials having differing characteristics. The marker 124 may be an RFID tag manufactured as part of the item 110 by the manufacturing apparatus 114 in response to the 3D manufacturing instructions 112. The marker 124 may be a pattern of voids manufactured as part of the item 110. The marker 124 may also include any combination, arrangement, and/or variation of any of the examples listed above. In some embodiments, marker information, such as the marker information 126 provided by the third party 130, may include a selection of a particular type and/or material of a marker 124 to be utilized.

The scanning apparatus 120 may include any appropriate components for detecting the marker 124. As non-limiting examples, the scanning apparatus 120 may include one or more instruments (e.g., transmitter, receiver, transducer, sensor, detector, or emitter) for producing and/or receiving signals and/or permeating wavelengths, such as for imaging using ultrasound, x-ray, ultraviolet, infrared, radio, optical, laser, magnetic resonance, nuclear magnetic resonance, radar, sonar, depth, density, thermal, chemical, holograph, radiometry, molecular, or photoacoustic technologies.

Any significance or meaning may be associated with a particular marker 124. Non-limiting examples of meanings that can be associated with a particular marker 124 include permissions, identifying information, authenticity information, contact information, source information, and production information, such as a time, place, or serial number associated with the production of the item 110. In some embodiments, a marker 124 may be associated with multiple meanings. As a non-limiting example, a marker 124 may include a QR code that indicates both an owner and date of manufacture of the marked item 110. In some embodiments, the marker 124 can be associated with permissions for the marked item 110, such as permissions to scan, manufacture, print, or otherwise reproduce the item 110. The permissions may indicate a number of times an action is permitted, including zero (i.e., not permitted), one (i.e., single use), a limited number (e.g., two or five times), or an unlimited number (e.g., an unrestricted use). In some embodiments, the permissions may include information about obtaining further permissions for the object 110. The marker 124 may provide commands, such as to provide a link to an interface, such as for payment, authorization, sign-in, etc. In some embodiments, the marker 124 may even include encoded manufacturing instructions 112 for making the marked item 110 and/or a link to where the instructions 112 can be accessed.

A marker 124 can be associated with a set of meanings of any degree of simplicity or complexity. On one end of the spectrum, a marker 124 may be part of a system having one type of marker with one meaning. For example, a marker 124 may be that an item is made of an ultraviolet plastic, and the corresponding meaning may be that reproduction of the marked item 110 carrying such a marker 124 is not authorized. A system of slightly greater complexity may include a finite number marker types and meanings. For example, the marker 124 may be that an item is made of an ultraviolet plastic that reflects a particular range of ultraviolet light, and each different range indicates a different third party supplier of the item. On another end of the spectrum, a marker 124 may be part of a system without a fixed number of types or meanings. For example, the marker 124 may include patterns constructed within the marked item 110 using any number of differentiating mechanisms (e.g., an infrared-detectible pattern with an ultraviolet-detectible pattern), and each patterns may indicate a unique identifier and/or a unique set of instructions.

### System Architecture

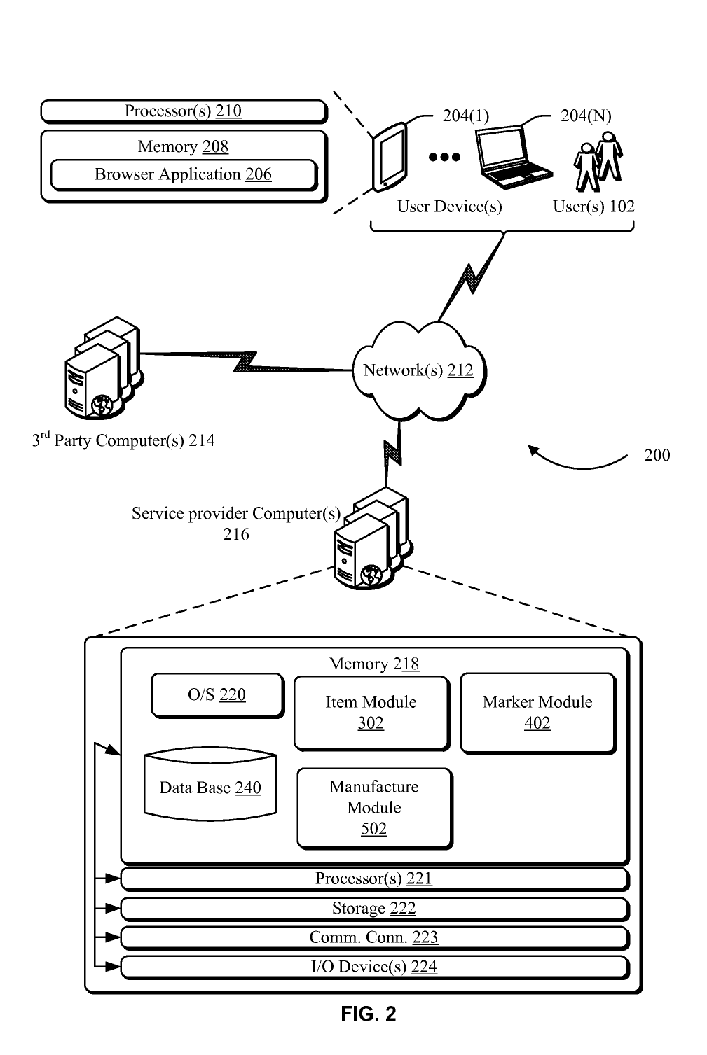

FIG. 2 depicts an illustrative system or architecture 200 in which techniques for providing and/or identifying marked items 110 may be implemented. In architecture 200, one or more users 102 may utilize user computing devices 204(1)-(N) (collectively, user devices 204) to access a browser application 206 (e.g., a web browser) or a user interface (UI) accessible through the browser application 206, via one or more networks 212. The “browser application” 206 can be any browser control or native application that can access and display a network page or other information. In some aspects, the browser application 206 may be hosted, managed, and/or provided by a computing resources service or service provider, such as by utilizing one or more service provider computers 216. The one or more service provider computers 216 may, in some examples, provide computing resources such as, but not limited to, client entities, low latency data storage, durable data storage, data access, management, virtualization, hosted-computing-system-based software solutions, electronic content performance management, etc. The one or more service provider computers 216 may also be operable to provide web or network hosting, computer application development, and/or implementation platforms, combinations of the foregoing, or the like to the one or more users 102.

In one illustrative configuration, the user devices 204 may include at least one memory 208 and one or more processing units or processor(s) 210. The processor(s) 210 may be implemented as appropriate in hardware, computer-executable instructions, firmware, or combinations thereof. Computer-executable instruction or firmware implementations of the processor(s) 210 may include computer-executable or machine-executable instructions written in any suitable programming language to perform the various functions described. The user devices 204 may also include geo-location devices (e.g., a global positioning system (GPS) device or the like) for providing and/or recording geographic location information associated with the user devices 204.

The memory 208 may store program instructions that are loadable and executable on the processor(s) 210, as well as data generated during the execution of these programs. Depending on the configuration and type of user device 204, the memory 208 may be volatile (such as random access memory (RAM)) and/or non-volatile (such as read-only memory (ROM), flash memory, etc.). The user device 204 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 208 may include multiple different types of memory, such as static random access memory (SRAM), dynamic random access memory (DRAM), or ROM.

Turning to the components of the memory 208 in more detail, the memory 208 may include an operating system and one or more application programs or services for implementing the features disclosed herein via the browser application 206 or dedicated applications (e.g., smart phone applications, tablet applications, etc.). The browser application 206 may be configured to receive, store, and/or display a website, a link to an electronic marketplace, or other interface for interacting with the one or more service provider computers 216. Additionally, the memory 208 may store access credentials and/or other user information such as, but not limited to, user IDs, passwords, and/or other user information. In some examples, the user information may include information for authenticating an account such as, but not limited to, a device ID, a cookie, an IP address, a location, or the like. In addition, the user information may include a user 102 provided response to a security question or a geographic location obtained by the user device 204.

In some examples, the networks 212 may include any one or a combination of many different types of networks, such as cable networks, the Internet, wireless networks, cellular networks and other private and/or public networks. While the illustrated example represents the users 102 accessing the browser application 206 over the networks 212, the described techniques may equally apply in instances where the users 102 interact with the one or more service provider computers 216 via the one or more user devices 204 over a landline phone, via a kiosk, or in any other manner. It is also noted that the described techniques may apply in other client/server arrangements (e.g., set-top boxes, etc.), as well as in non-client/server arrangements (e.g., locally stored applications, etc.).

As described briefly above, the browser application 206 may allow the users 102 to interact with the one or more service provider computers 216 (e.g., the computer systems 106 of the service provider 108), such as to access content like webpages or network pages. The one or more service provider computers 216, perhaps arranged in a cluster of servers or as a server farm, may host the browser application 206 and/or cloud-based software services. Other server architectures may also be used to host the browser application 206 and/or cloud-based software services. The browser application 206 may be capable of handling requests from many users 102 and serving, in response, various user interfaces that can be rendered at the user devices 204 such as, but not limited to, a webpage, a website, network site, or network page. The browser application 206 can interact with any type of website or network site that supports user interaction, including social networking sites, electronic retailers, informational sites, blog sites, search engine sites, news and entertainment sites, and so forth. The described techniques can similarly be implemented outside of the browser application 206, such as with other applications running on the user device 204.

The one or more service provider computers 216 may be any type of computing device such as, but not limited to, a mobile phone, a smart phone, a personal digital assistant (PDA), a laptop computer, a desktop computer, a server computer, electronic book (e-book) reader, a thin-client device, a tablet PC, etc. Additionally, it should be noted that in some embodiments, the one or more service provider computers 216 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment. In some examples, the one or more service provider computers 216 may be in communication with the user device 204 via the networks 212, or via other network connections. The one or more service provider computers 216 may include one or more servers, perhaps arranged in a cluster or as individual servers not associated with one another. The one or more service provider computers 216 may be in communication with one or more third party computers 214 (e.g., the computer systems 132 of the third party 130) via networks 212. The one or more service provider computers 216 that host the browser application 206 may obtain and provide data to third party computers 214 via networks 212 in accordance with embodiments described herein.

In one illustrative configuration, the one or more service provider computers 216 may include at least one memory 218 and one or more processing units or processors(s) 221. The processor(s) 221 may be implemented as appropriate in hardware, computer-executable instructions, firmware, or combinations thereof. Computer-executable instruction or firmware implementations of the processor(s) 221 may include computer-executable or machine-executable instructions written in any suitable programming language to perform the various functions described. The memory 218 may store program instructions that are loadable and executable on the processor(s) 221, as well as data generated during the execution of these programs. Depending on the configuration and type of the one or more service provider computers 216, the memory 218 may be volatile (such as RAM) and/or non-volatile (such as ROM, flash memory, etc.). The one or more service provider computers 216 or servers may also include additional storage 222, which may include removable storage and/or non-removable storage. The additional storage 222 may include, but is not limited to, magnetic storage, optical disks and/or tape storage. The disk drives and their associated computer-readable media may provide non-volatile storage of computer-readable instructions, data structures, program modules and other data for the computing devices. In some implementations, the memory 218 may include multiple different types of memory, such as SRAM, DRAM, or ROM.

The memory 218, the additional storage 222, both removable and non-removable, are all examples of non-transitory computer-readable storage media. For example, computer-readable storage media may include volatile or non-volatile, removable or non-removable media implemented in any method or technology for storage of information such as computer-readable instructions, data structures, program modules, or other data. The memory 218 and the additional storage 222 are all examples of computer storage media. Additional types of computer storage media that may be present in the one or more service provider computers 216 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium, which can be used to store the desired information and which can be accessed by the one or more service provider computers 216. Combinations of any of the above should also be included within the scope of computer-readable media.

The one or more service provider computers 216 may also contain communication connection(s) 223 that allow the one or more service provider computers 216 to communicate with a stored database, another computing device or server, user terminals and/or other devices on the networks 212. The one or more service provider computers 216 may also include I/O device(s) 224, such as a keyboard, a mouse, a pen, a voice input device, a touch input device, a display, speakers, a printer, etc.

Turning to the contents of the memory 218 in more detail, the memory 218 may include an operating system 220, one or more data stores 240 and/or one or more application programs, services, or other software modules, which are generally executed by a processor (e.g., the processors 210 and/or 221) for implementing the features disclosed herein.

Example modules are shown in FIG. 2, but functions and embodiments described herein can utilize a subset of the features provided by the modules and/or additional functions can be provided. Additionally, while the example modules will now be briefly discussed with regard to FIG. 2, further specific details regarding the example modules are provided below in the descriptions of subsequent Figures.

As an example module of memory 218, an item module 302 can be provided for receiving and/or processing orders 104 for items. The item module 302 may also determine whether an ordered item is to be produced as a marked item 110. The item module 402 may further be provided for obtaining and/or providing information related to the item to be produced as a marked item 110. A marker module 402 can be provided for obtaining and/or providing information related to a mark 124 to be included in a marked item 110. A manufacture module 502 can be provided for providing and/or generating instructions, for example the 3D manufacturing instructions 112 to the 3D manufacturing apparatus 114, which may be based at least in part on information accessed by the item module 302 and or marker module 402.

As can be understood, the 3D manufacturing instructions 112 and/or information associated therewith (such as item information 116, 126, and/or 136 and/or marker information 118, 128, and/or 138) may be obtained and stored well prior to receipt of orders 104 from users 102, so that the 3D manufacturing instructions 112 and/or associated information are available when an order 104 is placed. Moreover, the item module 302, the marker module 402, and/or the manufacture module 502 may also access any related item information, marker information, 3D manufacturing instructions, and/or detected information (e.g., 112, 116, 118, 122, 126, 128, 136, and/or 138) from any appropriate direct or intermediary source including user devices 204, 3^{rd} party computers 214, memory 218, database 240, 3D manufacturing apparatus 114, and/or scanning apparatus 120.

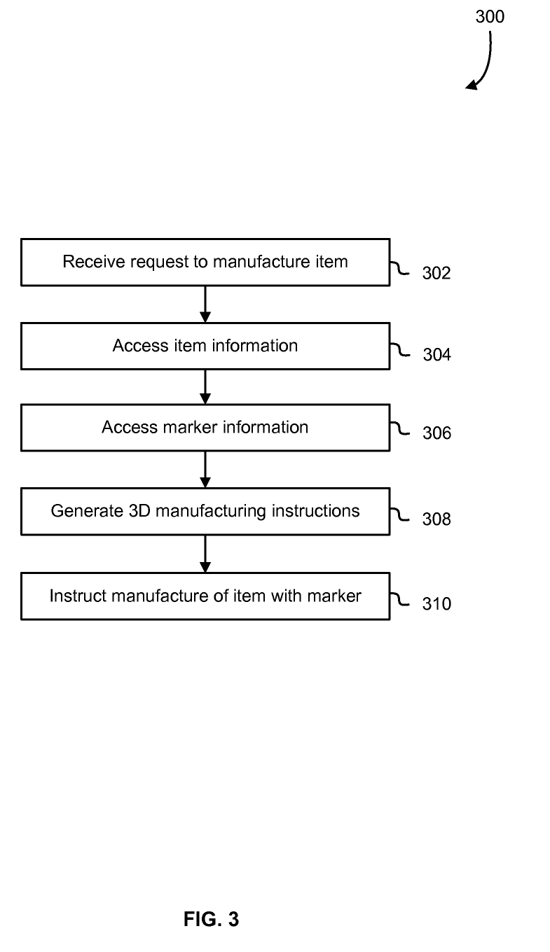

FIG. 3 is a flow chart representing an example process 300 for producing marked items 110 in accordance with some embodiments. Some or all of the process 300 (or any other processes described herein, or variations and/or combinations thereof) may be performed under the control of one or more computer systems configured with executable instructions, such as the modules described herein, and may be implemented as code (e.g., executable instructions, one or more computer programs or one or more applications) executing collectively on one or more processors, by hardware or combinations thereof. The code may be stored on a computer-readable storage medium, for example, in the form of a computer program including a plurality of instructions executable by one or more processors. The computer-readable storage medium may be non-transitory. Moreover, unless indicated otherwise, acts shown in the processes are not necessary performed in the order shown, and/or some acts can be omitted in embodiments.

The process 300 includes at 302 receiving a request to manufacture an item with a 3D manufacturing apparatus. For example, the user 102 may submit an order 104 to a computer 106 of a service provider, and/or request that manufacturing instructions 112 be sent to a manufacturing apparatus 114 to make an item 110. At 302, item information can be accessed. At 306, marker information can be accessed. For example, the item information and/or marker information may be accessed from memory, a third party, or a scanning apparatus, as previously described. At 308, 3D manufacturing instructions can be generated. For example, the 3D manufacturing instructions may be based on the accessed marker information and the item information, as previously described. At 310, manufacture of the item with a marker can be instructed. For example, the item may include any marker previously described herein to provide any information, permission, or command previously described herein.

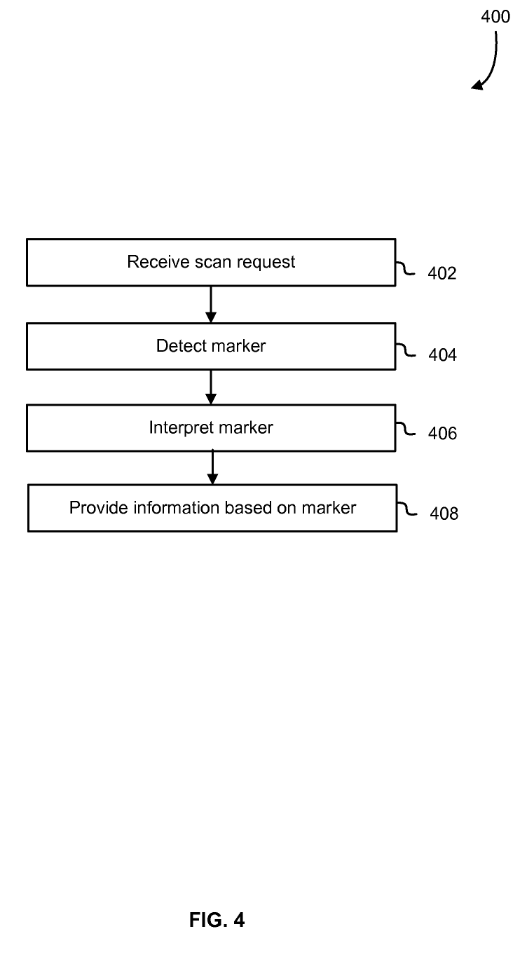

FIG. 4 is a flow chart representing an example process 400 for identifying marked items 110 in accordance with some embodiments. The process 400 includes at 402 receiving a request to scan an item. For example, the user 102 may wish to scan a first marked item 110 via a scanning apparatus 120 so as to obtain item information that is usable for generating 3D manufacturing instructions for manufacturing a second item based on the first item with a 3D manufacturing apparatus. At 402, a marker can be detected. For example, as previously described, the scanning apparatus may utilize any of the technologies described herein to detect the marker and/or obtain marker information about the marker. At 406, the marker can be interpreted. For example, the meaning of the marker may be determined by decoding the detected marker or comparing the detected marker against marker profiles stored in a database. At 408, information can be provided based on the marker. For example, as previously described, any information, permission, or command previously described herein may be provided based on the detected marker.

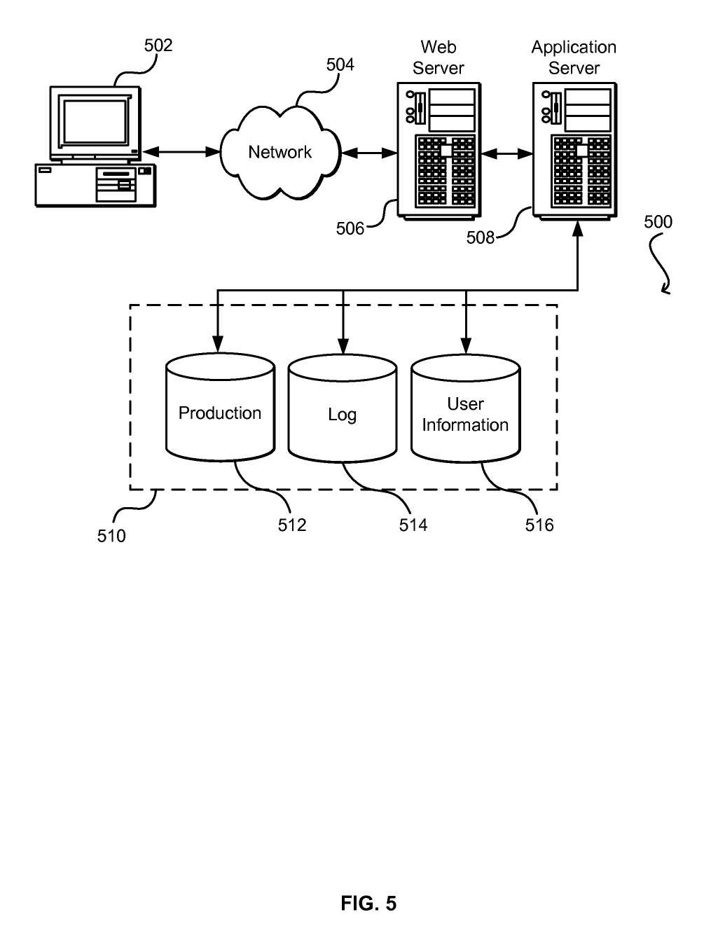

FIG. 5 illustrates aspects of an example environment 500 for implementing aspects in accordance with various embodiments. As will be appreciated, although a Web-based environment is used for purposes of explanation, different environments may be used, as appropriate, to implement various embodiments. The environment includes an electronic client device 502, which can include any appropriate device operable to send and receive requests, messages or information over an appropriate network 504 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 506 for receiving requests and serving content in response thereto, although for other networks an alternative device serving a similar purpose could be used as would be apparent to one of ordinary skill in the art.

The illustrative environment includes at least one application server 508 and a data store 510. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio and/or video to be transferred to the user, which may be served to the user by the Web server in the form of HyperText Markup Language (“HTML”), Extensible Markup Language (“XML”) or another appropriate structured language in this example. The handling of all requests and responses, as well as the delivery of content between the client device 502 and the application server 508, can be handled by the Web server.

It should be understood that the Web and application servers are not required and are merely example components, as structured code discussed herein can be executed on any appropriate device or host machine as discussed elsewhere herein.

The data store 510 can include several separate data tables, databases or other data storage mechanisms and media for storing data relating to a particular aspect. For example, the data store illustrated includes mechanisms for storing production data 512 and user information 516, which can be used to serve content for the production side. The data store also is shown to include a mechanism for storing log data 514, which can be used for reporting, analysis or other such purposes. It should be understood that there can be many other aspects that may need to be stored in the data store, such as for page image information and to access right information, which can be stored in any of the above listed mechanisms as appropriate or in additional mechanisms in the data store 510. The data store 510 is operable, through logic associated therewith, to receive instructions from the application server 508 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the client device 502. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium, which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

What is claimed is:

1. A method comprising:
receiving, by a computer system, scanned information about a first three-dimensional item, the first three-dimensional item produced by a first three-dimensional manufacturing apparatus based at least in part on a set of three-dimensional manufacturing instructions; the scanned information including marker information about a marker of the first three-dimensional item;
determining, based on the marker information, whether a permission to produce a copy of the first three-dimensional item exists;
providing, when the permission exists, instructions for manufacturing the copy of the first three-dimensional item with a second three-dimensional manufacturing apparatus; and
providing, when the permission does not exist, instructions that prevent manufacturing the copy of the first three-dimensional item with the second three-dimensional manufacturing apparatus.

2. The method of claim 1, wherein the instructions that prevent manufacturing comprise information that prevents the second three-dimensional manufacturing apparatus from obtaining item information from a scanning apparatus of the second three-dimensional manufacturing apparatus, the item information usable for generating three-dimensional manufacturing instructions for manufacturing a second three-dimensional item based at least in part on the first three-dimensional item with the second three-dimensional manufacturing apparatus.

3. The method of claim 1, wherein the instructions that prevent manufacturing comprise information that prevents the second three-dimensional manufacturing apparatus from generating three-dimensional manufacturing instructions from item information obtained from a scanning apparatus of the three-dimensional manufacturing apparatus, the item information usable for generating three-dimensional manufacturing instructions for manufacturing a second three-dimensional item based at least in part on the first three-dimensional item with the second three-dimensional manufacturing apparatus.

4. The method of claim 1, wherein the marker comprises a marker material that is different from other material used to manufacture the first three-dimensional item.

5. The method of claim 1, wherein the first three-dimensional item comprises a single material and the marker is a characteristic of the single material.

6. The method of claim 1, wherein the marker comprises at least one of:
a material having a particular response to a segment of an electromagnetic spectrum
a material having a particular color;
a material having a particular smell;
a material having a particular magnetic property;
a material having a particular density; or
a particular biological material.

7. The method of claim 1, wherein the marker comprises at least one of:
a radio-frequency identification (RFID) tag manufactured as part of the first three-dimensional item by the first three-dimensional manufacturing apparatus in response to the set of three-dimensional manufacturing instructions;
a pattern of voids manufactured as part of the first three-dimensional item by the first three-dimensional manufacturing apparatus in response to the set of three-dimensional manufacturing instructions; or
a pattern of materials having differing characteristics.

8. The method of claim 1, wherein receiving the scanned information about the first three-dimensional item comprises receiving information from a scanning apparatus that scans the first three-dimensional item using at least one of:
ultrasound waves;
x-ray waves;
radio waves;
ultraviolet waves; or
infrared waves.

9. A computer-readable storage medium having stored therein instructions that, when executed by one or more processors of a computer system, cause the computer system to perform operations comprising:
receiving detected information about a first item from a scan of the first item, the first item produced by a three-dimensional manufacturing process based at least in part on a set of three-dimensional manufacturing instructions; the detected information including marker information about a marker printed as part of the first item; and
determining, based at least in part on the marker, whether permission is granted for manufacturing a second item with a three-dimensional manufacturing apparatus.

10. The computer-readable storage medium of claim 9, wherein the permission for manufacturing the second item with the three-dimensional manufacturing apparatus is not granted based at least in part on the marker information.

11. The computer-readable storage medium of claim 10, wherein the instructions further cause the computer system to perform operations comprising:
receiving three-dimensional manufacturing instructions from a provider of the first item; and
providing the three-dimensional manufacturing instructions to the three-dimensional manufacturing apparatus for manufacturing the first item based at least in part on the three-dimensional manufacturing instructions rather than the scan of the first item.

12. The computer-readable storage medium of claim 9, wherein the permission for manufacturing the second item with the three-dimensional manufacturing apparatus is granted for manufacturing the first item a particular number of times identified by the permission.

13. The computer-readable storage medium of claim 9, wherein the three-dimensional manufacturing apparatus is different from a second three-dimensional manufacturing apparatus corresponding to the three-dimensional manufacturing process that produced the first item.

14. The computer-readable storage medium of claim 9, wherein the instructions further cause the computer system to perform operations comprising enabling a user to request rights for copying the first item with the three-dimensional manufacturing apparatus if the permission is not granted.

15. A system comprising:
a scanning device configured to scan a first item so as to obtain item information and marker information, the first item produced by a first three-dimensional manufacturing device based at least in part on a set of three-dimensional manufacturing instructions; the item information usable for generating a second set of three-dimensional manufacturing instructions for manufacturing a second item with a second three-dimensional manufacturing device based at least in part on the first item, the marker information obtained from a marker printed as part of the first item;
one or more processors; and
memory including instructions executable by the one or more processors that, when executed by the one or more processors, cause the system to at least:
instruct the scanning device to scan the first item;
identify the marker of the first item;
determine a plurality of commands associated with the second set of three-dimensional manufacturing instructions from the marker information extracted from the marker of the first item; and
provide the plurality of commands to the second three-dimensional manufacturing device.

16. The system of claim 15, wherein the system is further caused to at least identify whether permission is granted to copy the first item based at least in part on the marker information.

17. The system of claim 16, wherein at least one of the plurality of commands includes an instruction for the second three-dimensional manufacturing device to print the second item if the permission is granted.

18. The system of claim 15, wherein at least one of the permission or the plurality of commands is identified by comparing the marker information with a collection of permissions associated with a collection of markers stored in a storage device.

19. The system of claim 15, wherein at least one of the plurality of commands comprises an instruction for sending information that is based at least in part on the marker information to at least one of:
a supplier associated with the first item;
a third party associated with the first item;
a manufacturing apparatus; or
a user of the system.

20. The system of claim 15, wherein at least one of the plurality of commands comprises an instruction for at least one of:
providing a date that the first item was manufactured or scanned;
providing a location at which the first item was manufactured or scanned;
providing a link for requesting permission to reproduce the first item via a three-dimensional manufacturing apparatus; or
providing information about a provider of the first item.
